(19) United States
(12) Patent Application Publication
(10) Pub. No.: US 2022/0318962 A1
(43) Pub. Date: Oct. 6, 2022

(54) VIDEO SYSTEMS WITH REAL-TIME DYNAMIC RANGE ENHANCEMENT

(71) Applicant: PLANTRONICS, INC., SANTA CRUZ, CA (US)

(72) Inventors: YONGKANG FAN, BEIJING (CN); HAI XU, BEIJING (CN); XI LU, BEIJING (CN); HAILIN SONG, BEIJING (CN)

(73) Assignee: PLANTRONICS, INC., SANTA CRUZ, CA (US)

(21) Appl. No.: 17/593,897

(22) PCT Filed: Jun. 29, 2020
(86) PCT No.: PCT/CN2020/098719

§ 371 Date: Sep. 27, 2021

(51) Int. Cl. G06T 5/00; G06T 5/50; G06T 3/40; G06N 3/04

(52) U.S. Cl. CPC G06T 5/007; G06T 5/50; G06T 3/4046; G06N 3/04; G06T 2207/20084; G06T 2207/10024; G06T 2207/10016

(57) ABSTRACT

One illustrative method includes: (a) obtaining a video frame sequence having alternating fast and slow exposure frames; (b) applying a convolutional neural network twice to each frame in the video frame sequence, first when the frame is paired with a preceding frame, and again when the frame is paired with a subsequent frame, each time converting a pair of fast and slow exposure frames into an enhanced dynamic range video frame; and (c) outputting an enhanced video frame sequence. In another illustrative method, the convolutional neural network converts pairs of adjacent fast and slow exposure frames into corresponding pairs of enhanced dynamic range video frames. In yet another illustrative method, neighboring video frames for each given video frame are interpolated to form a fast and slow exposure frame pair, which the convolutional neural network converts into a corresponding enhanced dynamic range video frame.

### BACKGROUND

Computers and other digital systems typically employ 24-bit RGB format for color images and videos, using eight bits to represent the intensity of each of the red, green, and blue color components for each pixel. Though video cameras can supply, and video monitors can accept, various standardized digital and analog video formats, RGB (or “color component”) format is what most digital video equipment employs internally, particularly that equipment which performs image processing. Computer video cards and high-end video equipment often extend the RGB bit depth, employing 10, 12, 14, or more bits for each pixel color component. To qualify as a high dynamic range (“HDR”) image or video, each pixel color component must have at least 10 bits (30-bit RGB), coupled with a higher peak luminance level (10,000 cd/m² for SMPTE ST 2084). To distinguish them from HDR, non-HDR images or videos are often interchangeably termed standard-dynamic range (“SDR”) or low-dynamic range (“LDR”) videos.

Though camera sensor technology exists to capture HDR videos at 30 frames per second (“fps”), such technology is expensive. Most consumer cameras advertised as HDR cameras combine multiple LDR images captured by standard image sensors at different exposures. To provide 30 fps HDR video, such cameras require the use of additional image sensors or a single color image sensor that operates at 60 fps or higher. Unfortunately, most consumer video cameras cannot satisfactorily operate at this frame rate under indoor lighting conditions.

### SUMMARY

Accordingly, there are disclosed herein real-time video dynamic range enhancement systems and methods suitable for use with existing video cameras. In one example of this disclosure, a method includes: (a) obtaining a video frame sequence having alternating fast and slow exposure frames, the video frame sequence having a given frame rate; (b) applying a convolutional neural network twice to each frame in the video frame sequence, first when the frame is paired with a preceding frame, and again when the frame is paired with a subsequent frame, each application of the convolutional neural network converting a pair of fast and slow exposure frames into at least one enhanced dynamic range video frame; and (c) outputting the enhanced dynamic range video frames as an enhanced video frame sequence having the given frame rate.

An example of this disclosure includes a video system which includes: a video camera that generates a video frame sequence having alternating fast and slow exposures at a given frame rate; and at least one processing unit that operates twice on each frame in the video frame sequence, first when the frame is paired with a preceding frame, and again when the frame is paired with a subsequent frame, the at least one processing unit implementing a convolutional neural network to convert each pair of fast and slow exposure frames into at least one enhanced dynamic range video frame that forms part of an enhanced video frame sequence having the given frame rate.

Another example of this disclosure is a method that includes: (a) obtaining a video frame sequence having alternating fast and slow exposure frames; (b) converting pairs of adjacent fast and slow exposure frames into corresponding pairs of enhanced dynamic range video frames using a convolutional neural network; and (c) outputting at least some of the enhanced dynamic range video frames as an enhanced video frame sequence. A corresponding example video system includes: a video camera that generates a video frame sequence having alternating fast and slow exposures; and at least one processing unit that implements a convolutional neural network to convert pairs of adjacent fast and slow exposure frames into corresponding pairs of enhanced dynamic range video frames, the enhanced dynamic range video frames forming an enhanced video frame sequence.

Another example of this disclosure is a method that includes: (a) obtaining a video frame sequence having alternating fast and slow exposure frames, the video frame sequence having a given frame rate; (b) for each given video frame in the video frame sequence, interpolating between neighboring video frames to form an interpolated video frame, the given video frame and interpolated video frame forming a fast and slow exposure frame pair; (c) converting each of the fast and slow exposure frame pairs into a corresponding enhanced dynamic range video frame using a convolutional network; and (d) outputting the enhanced dynamic range video frames as an enhanced video frame sequence having the given frame rate. In at least one example of this disclosure, a video system includes: a video camera that generates a video frame sequence having alternating fast and slow exposures at a given frame rate; and at least one processing unit that implements an interpolator and a convolutional neural network. The interpolator operates to interpolate between neighboring video frames of each given video frame in the sequence to form an interpolated video frame, the given video frame and interpolated video frame forming a fast and slow exposure frame pair. The convolutional neural network operates to convert each of the fast and slow exposure frame pairs into a corresponding enhanced dynamic range video frame that forms part of an enhanced video frame sequence.

Each of the foregoing examples may be implemented individually or conjointly and may be implemented with one or more of the following features in any suitable combination: 1. obtaining includes configuring a video camera to provide alternating fast and slow exposure frames. 2. the convolutional neural network has a U-Net architecture using symmetric contracting and expanding paths to operate on a fast exposure frame paired with an adjacent slow exposure frame. 3. the fast and slow exposure frames are each supplied to the convolutional neural network as red, green, and blue, component planes. 4. the convolutional neural network converts each pair of fast and slow exposure frames into a corresponding pair of enhanced dynamic range video frames. 5. outputting includes real-time display or transmission of the enhanced video frame sequence. 6. outputting includes storage of the enhanced video frame sequence on a non-transient information storage medium. 7. a network interface that conveys the enhanced video frame sequence for real-time display by a remote video system. 8. a display interface that provides real-time display of the enhanced video frame sequence.

### BRIEF DESCRIPTION OF THE DRAWINGS

FIG. 1 shows an illustrative videoconferencing arrangement.

FIG. 2 is a block diagram of an illustrative videoconferencing system.

FIG. 3A shows a camera providing 30 frames-per-second (“fps”) low-dynamic range (“LDR”) video.

FIG. 3B shows a camera providing 60 fps LDR alternating-exposure video for conversion to 30 fps high-dynamic range (“HDR”) video.

FIG. 4 shows a camera providing 30 fps LDR alternating-exposure video with a first real-time dynamic range enhancement technique.

FIG. 5 shows a camera providing 30 fps LDR alternating-exposure video with a second real-time dynamic range enhancement technique.

FIG. 6 shows a first illustrative pipeline for real-time video dynamic range enhancement.

FIG. 7 shows a second illustrative pipeline for real-time video dynamic range enhancement.

FIG. 8 is an illustrative U-Net data flow diagram.

FIG. 9 is a flow diagram of an illustrative real-time LDR to HDR video conversion method.

### DETAILED DESCRIPTION

While specific embodiments are given in the drawings and the following description, keep in mind that they do not limit the disclosure. On the contrary, these examples provide the foundation for one of ordinary skill in the art to discern the alternative forms, equivalents, and modifications that are encompassed in the scope of the appended claims.

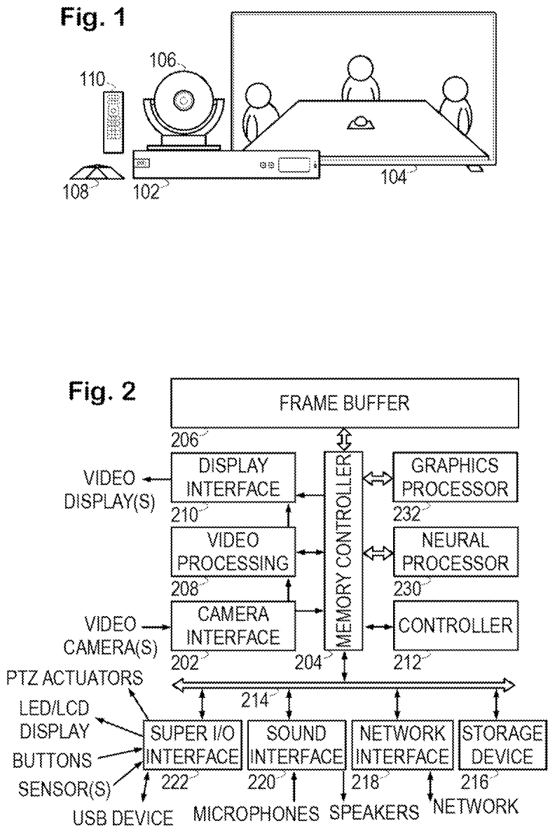

The disclosed video systems and conversion methods are best understood with reference to an illustrative context, such as the videoconferencing arrangement shown in FIG. 1. The arrangement includes a video conferencing system 102 that couples to various peripherals including a video display 104, a video camera 106, and a conferencing microphone/speaker 108. Users may control the system 102 via buttons on the system unit 103, via a remote control 110, or via other commercially available user input devices. Though FIG. 1 shows only one of each peripheral type, in practice the arrangement often includes multiple video displays, cameras, microphones, and speakers.

Video conferencing system 102 uses microphone(s) and video camera(s) (e.g., 106) to capture audio and video streams from attendees in a local conference room, and transmits those streams in real time to another video system in a remote location that plays the audio and video streams to remote attendees.

System 102 also receives real time audio and video streams of attendees in the remote location and uses the speakers 108 and video display 104 to play the streams for the local attendees. The system 102 thereby enables attendees in the local conference room to interact with the attendees in the remote location.

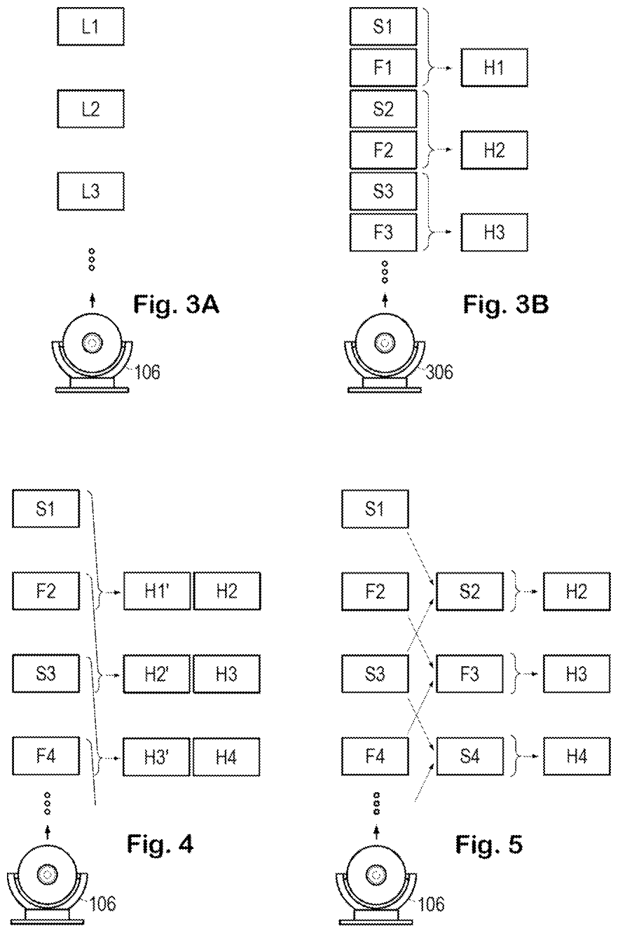

To enable the attendee interactions to be as natural as possible, it is desired to maximize the quality of the audio and video streams subject to limits on communications latency. In most indoor lighting situations, for example, high-dynamic range (“HDR”) video streams offer noticeably better video conferencing experiences than do low-dynamic range (“LDR”) video streams, so long as they are both delivered at comparable frame rates. Yet the video cameras in most existing video conferencing arrangements are LDR video cameras that cannot feasibly operate at 60 frames per second (“fps”) and consequently cannot provide 30 fps HDR in the conventional way (described further below with reference to FIG. 3B).

The illustrative video conferencing system 102 may have a block diagram such as that shown in FIG. 2. A camera interface 202 couples to the video camera(s) (106) to accept a video stream. If the video stream is in the 24-bit RGB format at 30 progressive fps, the camera interface 202 forwards the video stream to a memory controller 204, which routes the video stream to a video frame buffer 206. If the camera video stream is not in the desired format, the camera interface 202 routes the video stream to a video processing module 208, which converts the video stream into the 24-bit RGB format at 30 progressive fps, and forwards the converted video stream to memory controller 204 for routing to the frame buffer 206.

The frame buffer 206 buffers frames of both incoming (from the video camera 106) and outgoing (to the video display 104) video streams, providing an opportunity for the video conferencing system to process the streams before routing them onward. If the video display(s) (104) accept the buffered video stream format, the memory controller 204 routes the outgoing video stream from the frame buffer 206 to the display interface 210. If format conversion is needed, the memory controller 204 routes the outgoing video stream to the display interface 210 via the video processing module 208.

The operation of the memory controller 204 and the other components is controlled by controller 212, which may be a programmable processor running software stored in the storage device 216. The controller 212 accesses the software and associated data via the memory controller 204 and computer bus 214, retrieving the software from storage device 216, or optionally via network interface 218. Network interface 218 connects to a wired or wireless local area network, which in turn typically connects to the Internet, enabling the controller 212 to establish connections for sending and receiving data including audio and video streams.

Computer bus 214 further couples the memory controller 204 and controller 212 to a sound interface 220 for capturing incoming audio streams from the microphone(s) and for sending outgoing audio streams to the speaker(s) (108). The sound interface 220 may include a digital signal processor to process the audio streams based on parameters provided by the controller 212.

Computer bus 214 further couples the memory controller 204 and controller 212 to a “Super I/O” interface 222, an interface that bridges the high-speed computer bus 214 to lower-rate communications buses suitable for obtaining signals from front panel buttons and sensors (including a sensor for receiving signals from remote control 110); providing signals for illuminating LED indicators, displaying text on LCD panels, controlling pan, tilt, and zoom (“PZT”) actuators on video cameras; and exchanging data with USB drives or interface devices. The controller 212, when suitably configured by the stored software, is thus able to interact with a user to accept information regarding desired connection addresses and operating modes, and to provide the user with status information in addition to the desired video conferencing functionality.

While the programmable controller 212 may be able to process the buffered video frames in the manner described below, faster and more power-efficient operation can usually be achieved using a neural processing unit (“NPU”) 230 and/or a traditional graphics processing unit (“GPU”) 232 to perform such processing. GPUs employ circuitry optimized for vector functions typically associated with image processing, whereas NPUs provide circuitry optimized for matrix operations typically associated with implementing neural networks. These operations are closely related, differing mainly in their precision requirements and their data flow patterns. The controller 212 configures the operating parameters of the NPU 230 or GPU 232, and configures the memory controller 204 to provide the selected processing unit access to the frame buffer to carry out the desired processing operations, in this case conversion of incoming 30 fps LDR video streams to 30 fps HDR video streams.

As an initial matter, FIG. 3A shows a video camera 106 that captures LDR video frames at 30 fps. Three video frames are shown, labeled L1, L2, L3. Each frame is shown as a rectangle of pixels (e.g., 1600×900). Each pixel has three color components: red, green, and blue. Eight bits are used to indicate the intensity of each component, requiring 24 bits per pixel. The vertical spacing between frames is intended to represent a 33 millisecond (ms) interval.

FIG. 3B shows an HDR video camera 306 that captures LDR video frames at 60 fps. Within each 33 ms interval, the camera captures one frame with a comparatively slow exposure interval (e.g., 16 ms) and one frame with a comparatively fast exposure interval (e.g., 4 ms). To correspond with the 3-frame interval of FIG. 3A, FIG. 3B shows six frames, labeled S1, F1, S2, F2, S3, F3, with the Sx frames having the slow exposure and the Fx frames having the fast exposure. To provide 30 fps HDR, camera 306 combines the associated slow and fast exposure frames. Thus, S1 is combined with F1 to obtain an HDR frame H1, S2 is combined with F2 to obtain H2, and so on. Various HDR synthesis techniques are known and available in the academic literature. See, e.g., Debevec and Malik, “Recovering High Dynamic Range Radiance Maps from Photographs”, Assoc. Computing Machinery Special Interest Group on Computer Graphics (ACM SIGGRAPH) 1997. However, the shortened exposure times make it difficult for image sensors to perform well in low light conditions.

Accordingly, it is proposed herein to use the existing LDR video cameras 106, with their settings adjusted to provide 30 fps LDR video with alternating slow and fast exposure frames as shown in method 400 of FIG. 4.

FIG. 4 shows a camera providing 30 fps LDR alternating-exposure video in accordance with a first real-time dynamic range enhancement technique (method) 400. Four frames are shown with one frame captured per 33 ms interval. In the first interval, a comparatively slow exposure interval (e.g., 32 ms) is used, yielding frame S1. In the second interval, a comparatively fast exposure interval (e.g., 8 ms) is used, yielding frame F2. The next frames are S3, F4, etc. With the lower frame rate, motion may cause a greater degree of change between frames than would be expected for the 60 fps systems.

In accordance with method 400, a convolutional neural network is used to convert each adjacent pair of LDR video frames into a corresponding pair of HDR video frames. Thus, for example, frames S1 and F2 are combined to produce corresponding frames H1′ and H2. (The prime notation is used to distinguish the input pairing order. Unprimed frames are derived from a corresponding frame combined with a previous frame. Primed frames are derived from a corresponding frame combined with a subsequent frame.) F2 and S3 are combined to produce H2′ and H3. S3 and F4 are combined to produce H3′ and H4.

It is noted that, for reasons described further below, this technique yields two versions of each HDR video frame. As only one HDR video frame is needed for each 33 ms interval, one version of each HDR frame may be discarded. For reduced latency, the primed frames (H1′, H2′, H3′, etc.) can be discarded. For reduced processing burden, the HDR frames for every other adjacent pair are omitted, e.g., H1′ and H2 are used, H2′ and H3 are omitted, H3′ and H4 are used, etc. With this approach, about half of the neural network computation burden can be avoided.

The conversion technique of method 400 requires the neural network to cope with motion-induced differences between frames, a feature that can be readily implemented by deep convolutional neural networks. If this reliance is deemed undesirable, a separate interpolation step may be provided as shown in the conversion technique (method 500) of FIG. 5.

FIG. 5 shows a video camera (e.g., 106) providing 30 fps LDR alternating-exposure video in accordance with a second real-time dynamic range enhancement technique (method) 500. As in FIG. 4, video camera 106 in FIG. 5 provides 30 fps LDR video frames with alternating exposure intervals, labeled as S1, F2, S3, F4. A frame interpolator is applied to pairs of slow exposure frames to generate intermediate slow exposure frames. Thus, for example, S1 and S3 are interpolated to estimate S2. S3 and S5 are interpolated to estimate S4. Similarly, a frame interpolator operates on pairs of fast exposure frames to generate intermediate fast exposure frames. For example, F2 and F4 are interpolated to estimate F3. A neural network can then combine each fast exposure frame from the LDR video stream with an interpolated slow exposure frame for the same interval, and each slow exposure frame from the LDR video stream with an interpolated fast exposure frame for the same interval. For example, F2 is combined with S2 to obtain H2, S3 is combined with F3 to obtain H3, and so on. The effects of inter-frame motion are thereby minimized so that the neural network only operates to expand the dynamic range.

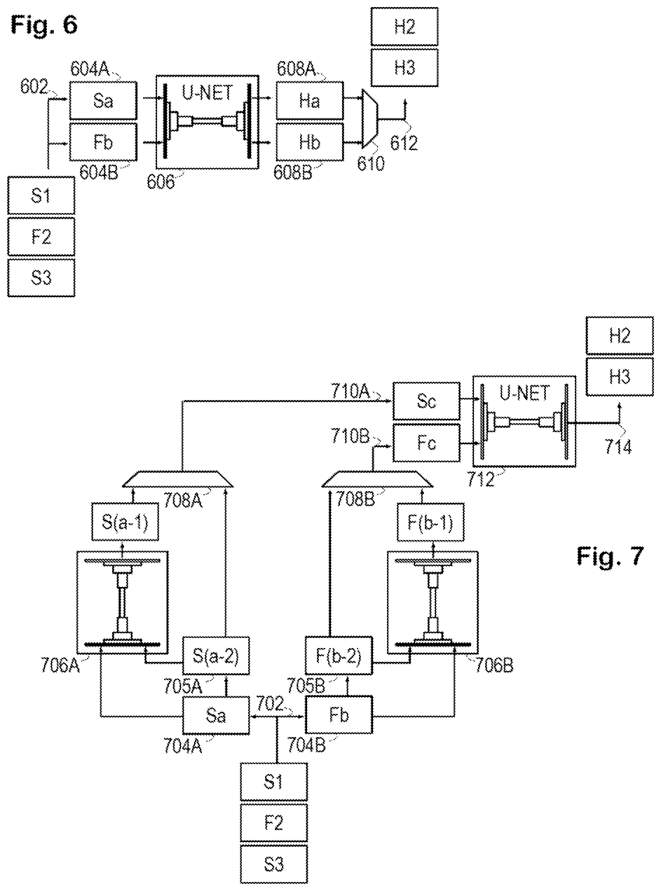

FIG. 6 shows an illustrative operations pipeline for implementing the first conversion technique. An input bus 602 couples the stream of 30 fps LDR video frames having alternating exposures to input buffers 604A, 604B. The slow exposure frames are captured by buffer 604A, while fast exposure frames are captured by buffer 604B. The frame in buffer 604A is labeled Sa, while the frame in buffer 604B is labeled Fb. As described with reference to FIG. 4, this conversion technique combines adjacent frames, and accordingly the frame indices a,b differ by one. Thus, for example, buffer 604A initially captures S1 and buffer 604B captures F2.

A convolutional neural network 606 combines the input frames Sa, Fb to produce a pair of HDR video frames Ha, Hb, which are stored in output buffers 608A, 608B, respectively. Network 606 thus operates on S1, F2 to produce H1′, H2. Once input buffer 604A captures S3, network 606 operates on S3 and F2 to produce H3, H2′. Then when input buffer 604B captures F4, network 606 operates on S3, F4 to produce H3′, H4.

A multiplexer 610 selects the output buffers in frame index order to provide a 30 fps HDR video stream on output bus 612. For example, output buffer 608B is selected to produce H2, buffer 608A is later selected to produce H3, then buffer 608B is again selected to produce H4. In this minimum latency example, the primed frames (H1′, H2′, H3′) are discarded.

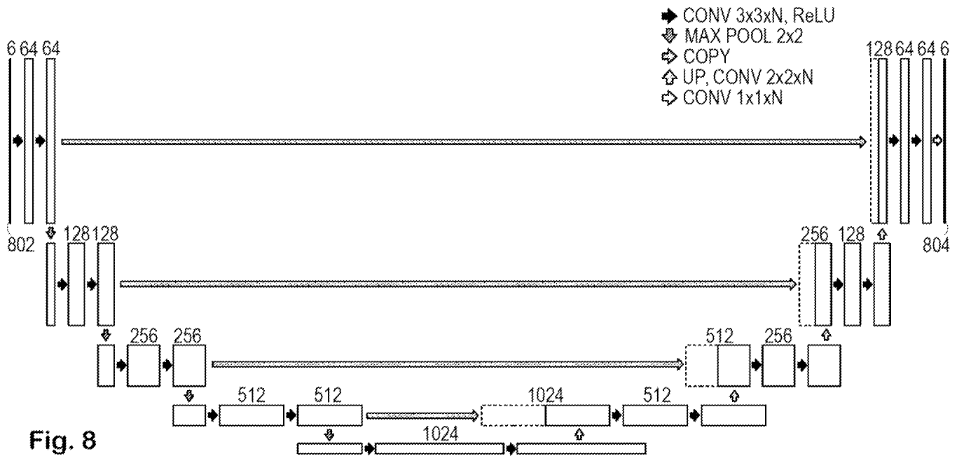

In the minimum computation approach, the network 606 only operates when both input buffers have captured new frames. When the input buffers hold S1, F2, the network produces H1′, H2. When the input buffers hold S3, F4, the network produces H3′, H4. Multiplexer 610 forwards the sequence H1′, H2, H3′, H4 to the output bus 612. The structure and operation of the neural network 606 is described in more detail below with reference to FIG. 8. The operations pipeline may be implemented by programming the video conferencing system controller (212) to appropriately configure the memory controller (204) and either the neural processor (230) or the graphics processor (232) for operations on video frames in the frame buffer (206).

FIG. 7 shows an illustrative operations pipeline for implementing the conversion technique of FIG. 5. An input bus 702 couples the stream of 30 fps LDR video frames having alternating exposures to input buffers 704A, 704B. Input buffer 704A captures slow exposure frames Sa, while input buffer 704B captures fast exposure frames Fb, with frame indices a,b differing by one. A delay buffer 705A stores a previous slow exposure frame S(a−2), while delay buffer 705B stores a previous fast exposure frame F(b−2). An interpolator 706A is coupled to buffers 704A, 705A to determine an interpolated slow frame S(a−1), and similarly an interpolator 706B is coupled to buffers 704B, 705B to determine an interpolated fast exposure frame F(b−1). Various suitable video frame interpolation techniques are available in the literature, including e.g., S. Nicklaus, “Sepconv-slomo: an implementation of video frame interpolation via adaptive separable convolution using PyTorch”, https://github.com/sniklaus/sepconv-slomo, 2017.

A multiplexer 708A alternately forwards delayed slow exposure frames (from buffer 705A) and interpolated slow exposure frames (from interpolator 706A) to produce a 30 fps LDR video stream of slow exposure frames Sc on internal bus 710A. Similarly, a multiplexer 708B alternately forwards fast exposure frames (from buffer 705B) and interpolated fast exposure frames Fc on internal bus 710B. The slow and fast exposure video streams are time aligned to provide corresponding fast and slow exposure frames for each 33 ms interval to the neural network 712. Neural network 712 combines the fast and slow exposure frames to produce a 30 fps HDR video stream on output bus 714.

Neural networks 606, 712, and potentially the interpolators 706A, 706B, may be convolutional neural networks that support deep learning, such as U-Net. As shown in FIG. 8, U-Net is a convolutional neural network with a symmetric contracting and expanding paths to capture contextual information while also enabling precise localization. Modifications are made to the U-Net architecture to provide each of the input images as parallel red, green, and blue planes, such that the input image pair forms six parallel image planes 802. The relative positions of the fast and slow exposure images is preserved regardless of the video frame indexes, with e.g., the first three planes being the red, green, and blue components of the fast exposure frame, and the second three planes being the red, green, and blue components of the slow exposure frame. Other arrangements are possible but should be employed consistently.

The modified U-Net architecture also provides red, green, and blue planes for the output image(s) 804. The U-Net network 606 (FIG. 6) produces two output images 804 in the form of six RGB image planes. Network 712 (FIG. 7) would produce a single HDR video frame in the form of 3 RGB image planes.

The operations of the U-Net architecture are “convolutional” in the sense that each pixel value of a result plane is derived from a corresponding block of input pixels using a set of coefficients that are consistent across the plane. The set of coefficients for the first operation corresponds to an input pixel volume of 3×3×N (3 pixels wide, 3 pixels high, and N planes deep), where N corresponds to the number of planes in the input layer (6 planes for input layer 802). Each plane in the result layer gets its own set of coefficients. The first result layer has 64 feature planes. The input pixel values are scaled by the coefficient values, and the scaled values are summed and “rectified”. The rectified linear unit operation (ReLU) passes any positive sums through but replaces any negative sums with zero.

A second result layer is derived from the first result layer using different coefficient sets corresponding to a pixel volume 3×3×64. The number of feature planes in the second result layer is kept at 64. The U-Net architecture then applies a “2×2 max pooling operation with stride 2 for down-sampling”, meaning that each 2×2 block of pixels in a given feature plane of the second result layer is replaced by a single pixel in a corresponding plane of the down-sampled result layer. The number of planes remains at 64, but the width and height of the planes is reduced by half.

A third result layer is derived from the first down-sampled result layer, using additional 3×3×64 coefficient sets to double the number of planes from 64 to 128. A fourth result layer is derived from the third result layer using coefficient sets of 3×3×128. A 2×2 max pooling operation is applied to the fourth result layer to produce a second down-sampled result layer having width and height dimensions a quarter of the original image dimensions. The depth of the second down-sampled result layer is 128.

A fifth result layer is derived from the second down-sampled result layer, using additional 3×3×128 coefficient sets to double the number of feature planes from 128 to 256. A sixth result layer is derived from the fifth result layer using coefficient sets of 2×3×256. A 2×2 max pooling operation is applied to the sixth result layer to produce a third down-sampled result layer having width and height dimensions one eight of the original image dimensions. The depth of the third down-sampled result layer is 256.

Seventh and eighth result layers are derived in similar fashion, as is a fourth down-sampled result layer having 512 planes with width and height dimensions one sixteenth of the original image dimensions. Ninth and tenth result layers are similarly obtained, but rather than down-sampling further, the U-Net architecture begins up-sampling. The pixel values in the planes of the tenth result layer are repeated to double the width and height of each plane. A set of 2×2×N convolutional coefficients is used to condense the number of up-sampled planes by half. The eighth result layer is concatenated with the condensed layer, forming a first concatenated layer having 1024 feature planes.

The eleventh result layer is derived from the first concatenated layer, using 512 coefficient sets of size 3×3×1024. The twelfth result layer is derived using 512 coefficient sets of size 3×3×512. A second concatenated layer is derived by up-sampling the twelfth layer, condensing the result, and concatenating the sixth result layer. 256 coefficient sets of size 3×3×512 are used to derive the 13th result layer from the second concatenated layer, and 256 coefficient sets of size 3×3×256 work to derive the 14th result layer from the 13th result layer.

A third concatenated result layer is derived from the 14th result layer using up-sampling, condensing, and concatenation with the fourth result layer. 15th and 16th result layers are derived in turn, the 16th result layer is up-sampled, condensed, and concatenated with the second result layer. 17th and 18th result layers are derived, each having 64 feature planes and the width, height dimensions of the original image. Finally, the planes of the 18th result layer are condensed with coefficient sets of 1×1×N to form the output images 804.

The number of planes in each result layer is a parameter that can be customized, as is the number of coefficients in each coefficient set. The coefficient values may be determined using a conventional neural network training procedure in which input patterns are supplied to the network to obtain a tentative output, the tentative output is compared with a known result to determine error, and the error is used to adapt the coefficient values. Various suitable training procedures, potentially including the use of augmented test data, are available in the open literature. More information can be found in Ronneberger, “U-Net: Convolutional Networks for Biomedical Image Segmentation”, arXiv:1505.04597v1 [cs.CV] 18 May 2015.

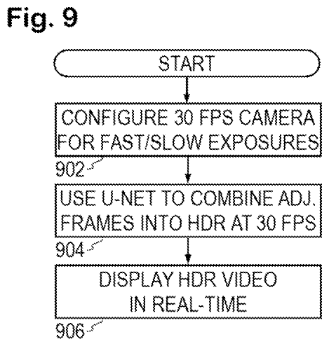

FIG. 9 is a flow diagram of an illustrative real-time LDR to HDR video conversion method, which may be implemented by the video system of FIG. 2 with or without cooperation of a second, remote video system. In block 902, the controller (212) configures the video camera (106) to provide a video frame sequence having alternating fast and slow exposures. Some video cameras may support this configuration with internal controls, though many will require the use of an external trigger signal with pulse widths that control each frame's exposure interval, in which case the controller (212) may configure the camera interface (202) to supply the appropriate trigger signal. For consumer video cameras in indoor lighting situations, a frame rate of 30 fps may be preferred.

In block 904, the controller (212) configures the memory controller (204) to direct the frame sequence to the frame buffer (206) and to provide the GPU (232) or NPU (230) access to operate on content of the frame buffer (206). The controller (212) further configures the GPU (232) or NPU (230) to implement a deep convolutional neural network preferably having the U-Net architecture described above. Other neural network architectures, such as ResNet, may also be suitable and are contemplated for use in the dynamic range enhancement process. The GPU (232) or NPU (230) then operates on the contents of the frame buffer (206), obtaining the red, green, blue components of fast and slow exposure frame pairs for conversion into one or more HDR video frames that form part of a enhanced video frame sequence having the same frame rate as the original video frame sequence.

In block 906, the controller (212) configures the memory controller (204) to direct the enhanced video frame sequence from the frame buffer (206) to the display interface (210) (for real-time display), the network interface (218) (for real-time transmission to a remote video system), and/or the information storage device (216) (for storage). In the context of video conferencing systems, the total latency between the video camera's capture of a given video frame and the real-time display of a corresponding enhanced video frame is kept below 500 ms, preferably including any delays for transmission to, and decoding by, the remote video system. Because two adjacent video frames are needed to produce an enhanced video frame, in at least one example, the minimum latency for local display is at least 66 ms, and for remote system display would likely exceed 100 ms. Thus, the term “real-time” as used herein includes operations that maintain such degrees of latency.

The foregoing dynamic range enhancement systems and techniques enable the display of greater detail in the brighter and dimmer parts of conference rooms, for example making hand-written text on a whiteboard much more readable. The increased dynamic range provided by systems and methods of this disclosure also facilitates the use of other automated processing techniques such as face detection.

Numerous alternative forms, equivalents, and modifications will become apparent to those skilled in the art once the above disclosure is fully appreciated. For example, the real time dynamic range enhancement can be employed with other video frame rates or with multi-exposure “still” cameras. The convolutional neural network may be embedded within the camera electronics or in the video system interface to the camera. The technology can also be employed by video systems having embedded cameras including smart phones and computers of all types (e.g., tablet, laptop, desktop, etc.). If the remote video system can be configured to generate the alternating exposure video frame sequences, the enhancement technology can be provided by the local video system. It is intended that the claims be interpreted to embrace all such alternative forms, equivalents, and modifications where permitted by the language of the claims.

What is claimed is:

1. A method of video dynamic range enhancement, the method comprising:
obtaining a video frame sequence comprising alternating fast and slow exposure frames, the video frame sequence having a given frame rate;
applying a convolutional neural network twice to each frame in the video frame sequence, first when the frame is paired with a preceding frame, and again when the frame is paired with a subsequent frame, each application of the convolutional neural network converting a pair of fast and slow exposure frames into at least one enhanced dynamic range video frame; and
outputting the enhanced dynamic range video frames as an enhanced video frame sequence having the given frame rate.

2. The method of claim 1, wherein said obtaining includes configuring, using a controller, a video camera to provide the alternating fast and slow exposure frames.

3. The method of claim 1, wherein the convolutional neural network has a U-Net architecture using symmetric contracting and expanding paths to operate on a fast exposure frame paired with an adjacent slow exposure frame.

4. The method of claim 3, wherein the fast and slow exposure frames are each supplied to the convolutional neural network as red, green, and blue, component planes.

5. The method of claim 3, wherein the convolutional neural network converts each pair of fast and slow exposure frames into a corresponding pair of enhanced dynamic range video frames.

6. The method of claim 1, wherein said outputting comprises real-time display of the enhanced video frame sequence.

7. A video system that comprises:
a video camera that generates, at a given frame rate, a video frame sequence having alternating fast and slow exposures; and
at least one processing unit that operates twice on each frame in the video frame sequence, first when the frame is paired with a preceding frame, and again when the frame is paired with a subsequent frame, the at least one processing unit implementing a convolutional neural network to convert each pair of fast and slow exposure frames into at least one enhanced dynamic range video frame that forms part of an enhanced video frame sequence having the given frame rate.

8. The video system of claim 7, further comprising a network interface that conveys the enhanced video frame sequence for real-time display by a remote video system.

9. The video system of claim 7, further comprising a display interface that provides real-time display of the enhanced video frame sequence.

10. The video system of claim 7, wherein the convolutional neural network has a U-Net architecture using symmetric contracting and expanding paths to operate on a fast exposure frame paired with an adjacent slow exposure frame.

11. The video system of claim 10, wherein each pair of fast and slow exposure frames is supplied to the convolutional neural network as pairs of red, green, and blue, component planes.

12. The video system of claim 10, wherein the processing unit converts each pair of fast and slow exposure frames into a corresponding pair of enhanced dynamic range video frames.

13. A method of video dynamic range enhancement, the method comprising:
obtaining a video frame sequence comprising alternating fast and slow exposure frames;
converting pairs of adjacent fast and slow exposure frames into corresponding pairs of enhanced dynamic range video frames using a convolutional neural network; and
outputting at least some of the corresponding pairs of enhanced dynamic range video frames as an enhanced video frame sequence.

14. The method of claim 13, wherein said obtaining includes configuring, using a controller, a video camera to provide the alternating fast and slow exposure frames.

15. The method of claim 13, wherein the convolutional neural network has a U-Net architecture using symmetric contracting and expanding paths.

16. The method of claim 15, wherein converting the pairs of adjacent fast and slow exposure frames into the corresponding pairs of enhanced dynamic range video frames using the convolutional neural network comprises supplying the pairs of adjacent fast and slow exposure frames to the convolutional neural network as pairs of red, green, and blue, component planes.

17. A video system that comprises:
a video camera that generates a video frame sequence having alternating fast and slow exposures; and
at least one processing unit that implements a convolutional neural network to convert pairs of adjacent fast and slow exposure frames into corresponding pairs of enhanced dynamic range video frames, the corresponding pairs of enhanced dynamic range video frames forming an enhanced video frame sequence.

18. The video system of claim 17, further comprising a network interface that conveys the enhanced video frame sequence for real-time display by a remote video system.

19. The video system of claim 17, wherein the convolutional neural network has a U-Net architecture using symmetric contracting and expanding paths.

20. The video system of claim 19, wherein the pairs of adjacent fast and slow exposure frames are each supplied to the convolutional neural network as red, green, and blue, component planes.
